(19) United States
(12) Patent Application Publication
(10) Pub. No.: US 2022/0200072 A1
(43) Pub. Date: Jun. 23, 2022

(54) Lithium battery with cap charging indication function

(71) Applicant: Hixon (Shenzhen) Technology Limited, Shenzhen (CN)

(72) Inventors: Qiu Deliang, Shenzhen (CN); Yang Xianlei, Shenzhen (CN)

(21) Appl. No.: 17/343,845

(22) Filed: Jun. 10, 2021

(30) Foreign Application Priority Data
Dec. 18, 2020 (CN) 202023065466.X

(51) Int. Cl. H01M 10/48; H02J 7/00; H01M 10/0525; H01M 10/42; H01M 50/186; H01M 50/107; H01M 50/121; H01M 50/119; H01M 50/593

(52) U.S. Cl. CPC H01M 10/488; H02J 7/0047; H01M 10/0525; H01M 10/425; H01M 2010/4271; H01M 50/107; H01M 50/121; H01M 50/119; H01M 50/593; H01M 50/186

(57) ABSTRACT

The invention discloses a lithium-ion battery with cap charging indication function, including PET sleeve, battery cell, support frame, steel sleeve, PCB board, ring nickel sheet, PET gasket and LED indicator, the inside of the PET sleeve is fixedly installed with cell, the top of cell is fixed with a support frame, the upper of the support frame is fixed with a PCB board, the middle of the upper part of the PCB board is fixed with an LED indicator, and the outside of the upper part of the PCB is fixed with a ring nickel sheet, the outer fixing sleeve of the support frame and the PCB board are installed with a steel sleeve, and the top of the steel sleeve is fixed with an insulating gasket. The invention of new type of PET sleeve is equipped with a cell, and the top of the cell is fixedly installed on the PCB board and the positive contact sheet through the support frame and the steel sleeve. The integrated welding of the board and the steel sleeve makes the cell connection structure simple, easy to assemble, and effectively improves the processing efficiency, and the top of the PCB board is equipped with an LED indicator to indicate the charging status, which is more convenient during charging and discharging.

The invention relates to a lithium ion battery, in particular to a lithium ion battery with a cap charging indicator function, and belongs to the technical field of batteries.

“Lithium battery” is a type of battery that uses lithium metal or lithium alloy as the positive/negative electrode material and uses a non-aqueous electrolyte solution. In 1912, the lithium metal battery was first proposed and studied by Gilbert N. Lewis. In the 1970s, M. S. Whittingham proposed and began to study lithium-ion batteries. Due to the very active chemical properties of lithium metal, the processing, storage and use of lithium metal have very high environmental requirements. With the development of science and technology, lithium-ion batteries have become the mainstream.

Rechargeable lithium-ion batteries are being used more and more widely due to their advantages of recyclability, high specific energy and long life. For example, at present, rechargeable lithium-ion batteries have become the main power supply batteries for mobile phones, laptops, cameras, and portable mobile power supplies. One of the applications is to replace primary batteries, such as toys, flashlights, smart homes, remote controls and other applications. The single-use cost of rechargeable lithium-ion batteries is lower than that of primary batteries, showing strong competitiveness, and primary batteries are gradually being replaced.

The existing alternative rechargeable lithium-ion batteries have no charging prompt function on the battery, no step-down conversion design, cannot directly replace AA, AAA and other primary batteries, and have many structural components, and the installation is more complicated and cumbersome. The processing efficiency is low, and at the same time, there is a lack of indication marks during charging, and the charging and discharging state cannot be indicated.

The purpose of the present invention is to provide a lithium-ion battery with a cap charging indicator function, through a step-down conversion design, to solve the problem that the existing lithium battery cannot directly replace the use of AA, AAA and other primary batteries, and constitute structural components, the installation is more complicated and cumbersome, the processing efficiency is low, and at the same time, there is a lack of indicator marks during charging, and the charging and discharging state cannot be indicated.

In order to achieve the above objectives, the present invention provides the following technical solutions: a lithium-ion battery with cap charging indication function, including a PET sleeve, a cell, a support frame, a steel sleeve, a PCB board, a ring-shaped nickel sheet and an LED indicator. The inside of the PET sleeve is fixedly installed with a cell, the top of the cell is fixedly installed with a support frame, the upper part of the support frame is fixed with a PCB board, and the middle of the upper part of the PCB board is fixedly installed with an LED indicator, the outer side of the upper part of the PCB is fixedly installed with a ring-shaped nickel sheet, the support frame and the outside of the PCB board are fixedly installed with a steel sleeve, and the LED indicator light passes through the ring-shaped nickel sheet and the steel sleeve and is placed in the middle of the top of the steel sleeve. An insulating gasket is fixed on the top of the sleeve.

To view other translation information of this related original text, you must enter the corresponding original text.

As a preferred technical solution of the present invention, a positive electrode contact piece is fixedly installed on the top of the steel sleeve, and the output pin of the positive electrode contact piece is fixedly connected to the electrical output terminal of the PCB board.

As a preferred technical solution of the present invention, an insulating gasket is fixedly installed on the top of the PET sleeve, and the insulating gasket is placed between the PET sleeve and the steel sleeve.

As a preferred technical solution of the present invention, one side of the bottom part of the PCB board is fixedly provided with an inductance component, the other side of the bottom part of the PCB board is fixedly provided with an IC component, and the side of the bottom part of the PCB board is fixedly installed MOS components.

As a preferred technical solution of the present invention, a bottom sheet is fixedly installed at the bottom of the PET sleeve, and the bottom sheet is placed between the PET sleeve and the cell.

Compared with the present technique, the beneficial effects of the present invention are:

The invention is a lithium-ion battery with a cap charging indicator function. A cell is arranged inside of the PET sleeve, and the top of the cell is fixedly installed on the PCB board and the positive electrode contact piece through a support frame and a steel sleeve. The steel sleeve is provided to make the battery, the components are integrated, and the ring-shaped nickel sheet, PCB board and steel sleeve are integrated welded, which makes the cell connection structure simple, easy to assemble, and effectively improves the processing efficiency. The top of the PCB board is equipped with an LED indicator to check the charging status instructions, more convenient when charging and discharging.

### DESCRIPTION OF THE DRAWINGS

FIG. 1 is a schematic diagram of the structure of the present invention;

FIG. 2 is a schematic diagram of the internal structure of the PET sleeve of the present invention;

FIG. 3 is a schematic diagram of the assembly structure of the PCB board and the positive electrode contact piece in the present invention;

FIG. 4 is a schematic diagram of the internal structure of the PCB board in the present invention.

In the picture: 1. Bottom film; 2. Cell; 3. Support frame; 4. Steel sleeve; 5. PCB board; 6. Ring nickel sheet; 7. PET gasket; 8. Positive contact sheet; 9. PET sleeve 10. LED indicator light; 11. inductive components; 12. IC components; 13. MOS components.

The following will clearly and completely describe the technical solutions in the embodiments of the present invention with reference to the accompanying drawings in the embodiments of the present invention. Obviously, the described embodiments are only a part of the new-type embodiments of the present invention, rather than all the embodiments. Based on the embodiments of the present invention, all other embodiments obtained by those of ordinary skill in the area without creative work shall fall within the protection scope of the present invention.

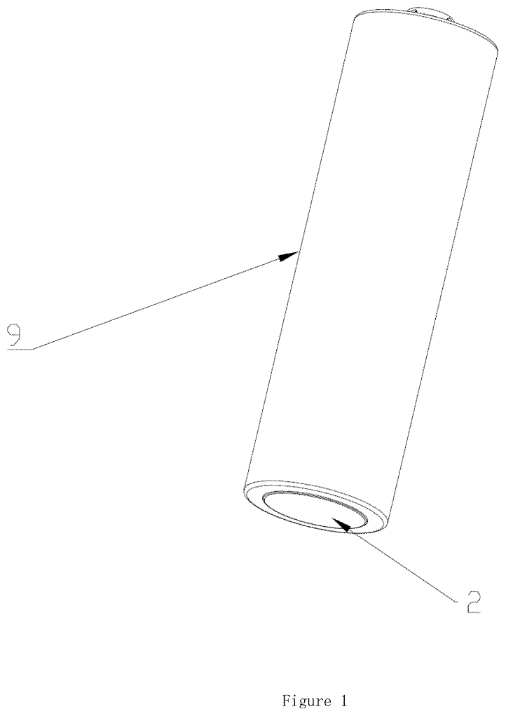

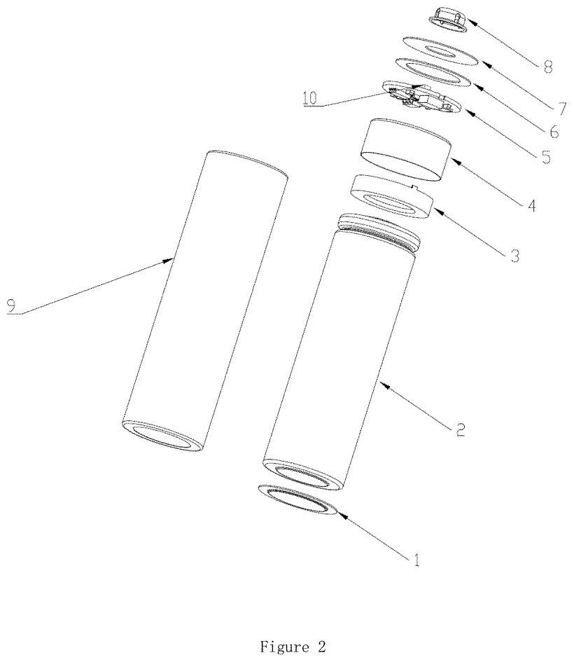

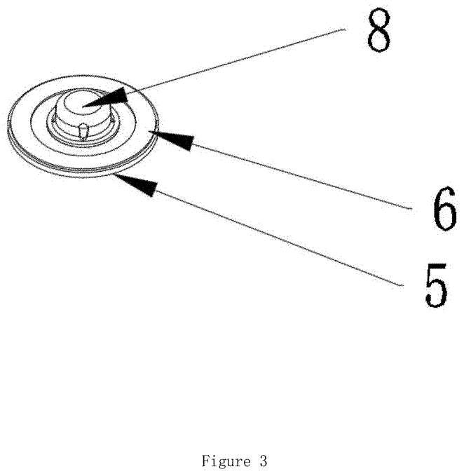

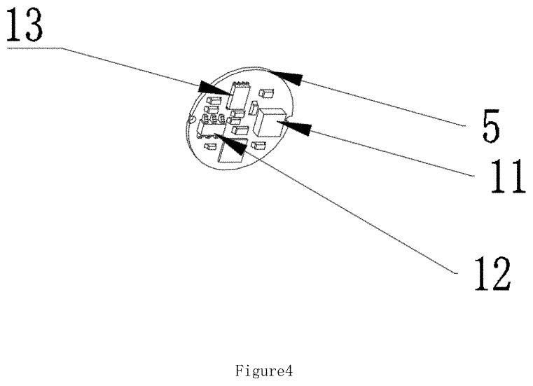

Referring to FIGS. 1-4, the present invention provides a technical solution for a lithium-ion battery with a cap charging indicator function: a lithium-ion battery with a cap charging indicator function, including a PET sleeve 9, a cell 2, a support frame 3, a steel sleeve 4, a PCB board 5, a ring-shaped nickel sheet 6 and a LED indicator light 10, the inside of the PET sleeve 9 is fixedly installed with the cell 2, the top of the cell 2 is fixedly installed with a support frame 3, and the upper of the support frame 3 is fixedly installed with a PCB board 5, the middle of the upper part of the PCB board 5 is fixedly installed with an LED indicator light 10, the outer side of the upper part of the PCB board 5 is fixedly installed with a ring-shaped nickel sheet 6, the support frame 3 and the outside of the PCB board 5 are fixedly installed with a steel sleeve 4, and The LED indicator light 10 passes through the ring-shaped nickel sheet 6 and the steel sleeve 4 and is placed in the middle of the top of the steel sleeve 4, and an insulating gasket 7 is fixed on the top of the steel sleeve 4.

A positive electrode contact piece 8 is fixedly installed on the top of the steel sleeve 4, and the output pin of the positive electrode contact piece 8 is fixedly connected with the electrical output terminal of the PCB board 5.

An insulating gasket 7 is fixedly installed on the top of the PET sleeve 9, and the insulating gasket 7 is placed between the PET sleeve 9 and the steel sleeve 4.

An inductance component 11 is fixed on one side of the bottom end of the PCB board 5, an IC component 12 is fixed on the other side of the bottom end of the PCB board 5, and a MOS component 13 is fixedly installed on the side of the bottom end of the PCB board 5.

A bottom sheet 1 is fixedly installed at the bottom of the PET sleeve 9, and the bottom sheet 1 is placed between the PET sleeve 9 and the cell 2.

In specific use, the present invention is a lithium-ion battery with a cap charging indicator function. A cell 2 is arranged inside the PET sleeve 9. A support frame 3 and a steel sleeve 4 are provided on the top of the cell 2 to the PCB board 5 and the positive electrode contact piece 8. For fixed installation, the steel sleeve 4 is provided to make the components of the battery into a whole. The internal structure of the lithium-ion battery composed of the cell 2, the support frame 3, the steel sleeve 4, the PCB board 5 and the positive electrode contact sheet 8 can be installed directly on the top of the cell 2, easy to assemble, and effectively improve the processing efficiency. At the same time, the PCB board 5 provides protection to the cell 2 when it charged and discharged. At the same time, the positive contact piece 8, the ring-shaped nickel piece 6, the PCB board 5 and the steel sleeve 4 are integrated and welded, and the top of the PCB board 5 is provided with an LED indicator 10, which can indicate the charging status, which is more convenient during charging and discharging.

In the description of the present invention, it should be understood that the indicated orientation or positional relationship is based on the orientation or positional relationship shown in the drawings, which is only for the convenience of describing the present invention and simplifying the description, and does not indicate or imply the pointed device or the element must have a specific orientation, be constructed and operated in a specific orientation, and therefore cannot be understood as a limitation of the present invention.

In the present invention, unless otherwise clearly specified and limited, for example, it can be a fixed connection, a detachable connection, or a whole; it can be a mechanical connection or an electrical connection; it can be a direct connection or Indirect connection through an intermediary can be the internal communication between two elements or the interaction between two elements. Unless otherwise clearly defined, those of ordinary skill in the art can understand that the above terms are used in the present invention according to specific circumstances. The specific meaning in the new model.

Although the embodiments of the present invention have been shown and described, those of ordinary skill in the art can understand that various changes, modifications, and substitutions can be made to these embodiments without departing from the principle and spirit of the present invention. And variations, the scope of the present invention is defined by the appended claims and their equivalents.

1. A lithium-ion battery with cap charging indication function, including a PET sleeve 9, a cell 2, a support frame 3, a steel sleeve 4, a PCB board 5, a ring-shaped nickel sheet 6, a PET gasket 7 and an LED indicator 10, It is characterized in that the inside of the PET sleeve 9 is fixedly installed with a cell 2, a support frame 3 is fixedly installed on the top of the cell 2, and the upper part of the support frame 3 is fixedly provided with a PCB board 5. An LED indicator light 10 is fixedly installed at the middle of the upper end of the board 5, a ring-shaped nickel sheet 6 is fixedly installed on the outside of the upper part of the PCB 5, a steel sleeve 4 is fixedly installed on the outside of the support frame 3 and the PCB board 5, and the LED indicator light 10 it passes through the ring-shaped nickel sheet 6 and the steel sleeve 4 and is placed in the middle of the top end of the steel sleeve 4, and the top end of the steel sleeve 4 is fixedly provided with an insulating gasket 7.

2. The lithium-ion battery with cap charging indication function according to claim 1, characterized in that: the top of the steel sleeve 4 is fixedly installed with a positive electrode contact piece 8, and the output pin of the positive electrode contact piece 8 It is fixedly connected to the electrical output terminal of the PCB board 5.

3. The lithium battery with cap charging indication function according to claim 1, characterized in that: the top of the PET sleeve 9 is fixedly installed with an insulating gasket 7, and the insulating gasket 7 is placed on the PET between the PET sleeve 9 and the steel sleeve 4.

4. The lithium battery with cap charging indication function according to claim 1, characterized in that: one side of the bottom part of the PCB board 5 is fixedly provided with an inductance component 11, and the other side of the bottom part of the PCB board 5 is provided an IC component 12, and a MOS component 13 is fixedly installed on the side of the bottom part of the PCB board 5.

5. The lithium battery with cap charging indication function according to claim 1, characterized in that: the bottom of the PET sleeve 9 is fixedly installed with a bottom sheet 1, and the bottom sheet 1 is placed between the PET sleeve 9 and cell 2.
